(19) United States
(12) Patent Application Publication
(10) Pub. No.: US 2026/0338735 A1
(43) Pub. Date: Oct. 29, 2026

(54) SYSTEMS AND METHODS FOR DIFFERENTIAL MOBILITY SPECTROMETRY WITH ALTERNATING SEPARATION VOLTAGE CAPTURE

(71) Applicant: DH Technologies Development Pte. Ltd., Singapore (SG)

(72) Inventor: Yves LEBLANC, Newmarket (CA)

(73) Assignee: DH Technologies Development Pte. Ltd., Singapore (SG)

(21) Appl. No.: 19/113,564

(22) PCT Filed: Sep. 21, 2023
(86) PCT No.: PCT/IB2023/059316

§ 371 Date: Mar. 20, 2025

Related U.S. Application Data
(60) Provisional application No. 63/377,105, filed on Sep. 26, 2022.

(51) Int. Cl. G01N 27/624; G01N 27/623

(52) U.S. Cl. CPC G01N 27/624; G01N 27/623

(57) ABSTRACT

A method and system of DMS analysis using a DMS device, the method including introducing a sample at an opening of the DMS device, sequentially applying a plurality of separation voltages between opposing electrodes, wherein for each applied separation voltage: applying a plurality of incrementally increasing compensation voltages between the opposing electrodes, following each applied compensation voltage: interrupting application of the separation voltage and of the compensation voltage, collecting MS data for the sample exiting the DMS device while the separation voltage and the compensation voltage are interrupted, and determining an optimum compensation voltage out of the plurality of compensation voltages based on the collected MS data, repeating the sequentially applying the plurality of separation voltages to the introduced sample a plurality of times, and determining a CCS value for the sample based on the applied separation voltages and their corresponding determined optimum compensation voltages.

### CROSS-REFERENCE TO RELATED APPLICATIONS

This application is being filed on Sep. 20, 2023, as a PCT International Patent Application that claims priority to and the benefit of U.S. Provisional Application No. 63/377,105, filed on Sep. 26, 2022, which is hereby incorporated by reference in its entirety.

### BACKGROUND

Differential mobility spectrometry (DMS) devices may be used to predict collision cross-section (CCS) values of unknown compounds, and on the basis of the predicted CCS values, determine the identity of the unknown compounds. DMS devices allow for the determination of CCS values by evaluating the variations of the intensities of transmitted ions as measured in a mass spectrometry (MS) scan performed at a plurality of separation voltages (SV), sometimes referred to as dispersion voltages, and compensation voltages (CV) to establish an SV-CoV transmission curve. The determined SV-CV data can be converted to account for differences in instrument geometry (dimensionless) and represented as alpha function (or curve) over limited range and used to determine the CCS.

### SUMMARY

In one aspect, the technology relates to a method of differential mobility spectrometry (DMS) analysis using a DMS device, the method including introducing a sample at an opening of the DMS device, sequentially applying a plurality of separation voltages between opposing electrodes of the DMS device, wherein sequentially applying the plurality of separation voltage includes, for each applied separation voltage: applying a plurality of incrementally increasing compensation voltages between the opposing electrodes of the DMS device, following each applied compensation voltage: interrupting application of the separation voltage and of the compensation voltage, collecting mass spectrometry (MS) data for the sample exiting the DMS device while the separation voltage and the compensation voltage are interrupted, and determining an optimum compensation voltage out of the plurality of compensation voltages based on the collected MS data, the optimum compensation voltage corresponding to the applied separation voltage, repeating the sequentially applying the plurality of separation voltages to the introduced sample a plurality of times, and determining a collision cross-section (CCS) value for the sample based on the applied separation voltages and their corresponding determined optimum compensation voltages variation as a function of the applied separation voltages.

In an example of the above aspect, sequentially applying the plurality of separation voltages includes sequentially applying a plurality of RF separation voltages. In an example, the RF separation voltages include voltages of different frequencies. In another example, the RF separation voltages include voltages generating a combined asymmetric waveform. In further examples, sequentially applying the plurality of separation voltages includes sequentially applying more than two separation voltages. In other examples, sequentially applying the plurality of separation voltages includes sequentially applying two to twenty separation voltages. In further examples, sequentially applying the plurality of separation voltages includes sequentially applying the plurality of separation voltages over a maximum range of voltages allowable in the DMS device. In other examples, sequentially applying the plurality of separation voltages includes sequentially applying the plurality of separation voltages over a sub-range of a maximum number of voltages allowable in the DMS device. For example, the sub-range of the maximum number of voltages is a second half of the maximum range of voltages allowable in the DMS device.

In other examples of the above aspect, sequentially applying the plurality of separation voltages includes sequentially applying the plurality of separation voltages over a range of 0 V to 4200 V. In further examples, sequentially applying the plurality of separation voltages includes sequentially applying the plurality of separation voltages over a range of 2100 V to 4200 V. In yet another example, sequentially applying the plurality of separation voltages includes sequentially applying discrete incremental separation voltages. For example, sequentially applying discrete incremental separation voltages includes applying separation voltages separated by a voltage increment in a range of 50 V to 250 V.

In further examples of the above aspect, the opposing electrodes of the DMS device are opposing planar electrodes, and sequentially applying the plurality of separation voltages includes sequentially applying the plurality of separation voltages between the opposing planar electrodes. In another example, the opposing electrodes of the DMS device are opposing curved electrodes, and sequentially applying the plurality of separation voltages includes sequentially applying the plurality of separation voltages between the opposing curved electrodes. In a further example, applying the plurality of incrementally increasing compensation voltages includes applying a plurality of incrementally increasing DC compensation voltages. In another example, collecting the MS data includes performing a single MS scan. In yet a further example, collecting the MS data includes performing an MS/MS scan. In an example, collecting the MS data is performed at a frequency of 2 Hz. In other examples, repeating the sequentially applying the plurality of separation voltages is performed over a predetermined period of time. For example, the predetermined period of time corresponds to an elution time associated with a chromatography peak.

In other examples of the above aspect, repeating the sequentially applying the plurality of separation voltages includes sequentially applying the plurality of separation voltages 3 or more times. In another example, repeating the sequentially applying the plurality of separation voltages includes sequentially applying the plurality of separation voltages 3 to 15 times. In yet another example, the method further includes identifying one or more compounds present in the sample based on the determined CCS value. For example, the one or more compounds are identified based on a comparison of the determined CCS value with contents of a library of SV-CV curves. As another example, the one or more compounds are identified based on modeling of the determined CCS value.

In another aspect, the technology relates to a system of differential mobility spectrometry (DMS), the system including a sample input device, a DMS device fluidically coupled to the sample input device, a DC voltage source, an RF voltage source, a mass analysis device, a processor operatively coupled to the DMS device, the DC voltage source, the RF voltage source and the mass analysis device, and a memory coupled to the processor, the memory storing instructions that, when executed by the processor, perform a set of operations. In one aspect, the set of operations include introducing, via the sample input device, a sample at an opening of the DMS device, sequentially applying, via the RF voltage source, a plurality of separation voltages between opposing electrodes of the DMS device, wherein sequentially applying the plurality of separation voltage includes, for each applied separation voltage: applying, via the DC voltage source, a plurality of incrementally increasing compensation voltages between the opposing electrodes of the DMS device, following each applied compensation voltage: interrupting, via the processor, application of the separation voltage and of the compensation voltage, collecting, via the processor and the mass analysis device, mass spectrometry (MS) data for the sample exiting the DMS device while the separation voltage and the compensation voltage are interrupted, and determining, via the processor, an optimum compensation voltage out of the plurality of compensation voltages based on the collected MS data, the optimum compensation voltage corresponding to the applied separation voltage, repeating, via the processor, the sequentially applying the plurality of separation voltages to the introduced sample a plurality of times, and determining, via the processor, a collision cross-section (CCS) value for the sample based on the applied separation voltages and their corresponding determined optimum compensation voltages.

In other examples of the above aspect, the set of instructions includes sequentially applying the plurality of separation voltages by sequentially applying a plurality of RF separation voltages. In a further example, the RF separation voltages include voltages of different frequencies. For example, the RF separation voltages include voltages generating a combined asymmetric waveform. In another example, the set of instructions includes sequentially applying the plurality of separation voltages by sequentially applying more than two separation voltages. In a further example, the set of instructions includes sequentially applying the plurality of separation voltages by sequentially applying two to twenty separation voltages. In yet another example, the set of instructions includes sequentially applying the plurality of separation voltages by sequentially applying the plurality of separation voltages over a maximum range of voltages allowable in the DMS device. In other examples, the set of instructions includes sequentially applying the plurality of separation voltages by sequentially applying the plurality of separation voltages over a sub-range of a maximum number of voltages allowable in the DMS device. For example, the sub-range range of the maximum number of voltages is a second half of the maximum number of voltages allowable in the DMS device.

In further examples of the above aspect, the set of instructions includes sequentially applying the plurality of separation voltages by sequentially applying the plurality of separation voltages over a range of 0 V to 4200 V. In yet other examples, the set of instructions includes sequentially applying the plurality of separation voltages by sequentially applying the plurality of separation voltages over a range of 2100 V to 4200 V. In another example, the set of instructions includes sequentially applying the plurality of separation voltages by sequentially applying discrete incremental separation voltages. For example, the set of instructions includes sequentially applying discrete incremental separation voltages separated by a voltage increment in a range of 50 V to 250 V. In a further example, the opposing electrodes of the DMS device are opposing planar electrodes, and the set of instructions includes sequentially applying a plurality of separation voltages by sequentially applying the plurality of separation voltages between the opposing planar electrodes. In other examples, the opposing electrodes of the DMS device includes are opposing curved electrodes, and the set of instructions includes sequentially applying a plurality of separation voltages by sequentially applying the plurality of separation voltages between the opposing curved electrodes.

In further examples of the above aspect, the set of instructions includes applying the plurality of incrementally increasing compensation voltages by applying a plurality of incrementally increasing DC compensation voltages. In an additional example, the set of instructions includes collecting the MS data by performing a single MS scan. In yet other examples, the set of instructions includes collecting the MS data by performing an MS/MS scan. In another example, the set of instructions includes collecting the MS data at a frequency of 2 Hz. In other examples, the set of instructions includes repeating the sequentially applying the plurality of separation voltages over a predetermined period of time. For example, the predetermined period of time corresponds to an elution time associated with a chromatography peak. In further examples, the set of instructions includes repeating the sequentially applying the plurality of separation voltages 3 or more times. In other examples, the set of instructions includes repeating the sequentially applying the plurality of separation voltages 3 to 15 times. In yet other examples, the set of instructions further includes identifying one or more compounds present in the sample based on the determined CCS value. In another example, the one or more compounds are identified based on a comparison of the determined CCS value with contents of a library of SV-CV curves. In yet another example, the one or more compounds are identified based on modeling of the determined CCS value. In yet another example, the one or more compounds are identified based on a partial alpha-curve function derived from an SV-CV curve and compared to a library of alpha-curve function.

### BRIEF DESCRIPTION OF THE DRAWINGS

FIGS. 1A and 1B are schematic illustrations of example system differential mobility spectrometry (DMS) devices.

FIG. 2 is an example DMS dispersion plot showing the preferred compensation voltage (CV) and separation voltage (SV) values for ion transmission of two known compounds with different collision cross-sections (CCSs).

FIG. 3 is a schematic diagram illustrating the process of using DMS measurement data to predict the collision cross-section (CCS) of an unknown compound.

FIGS. 4A and 4B illustrate a method of DMS analysis using a DMS device, according to various examples of the disclosure.

FIGS. 5A-5E depict data collection and analysis using a DMS device, according to various examples of the disclosure.

FIG. 6 is a flow chart depicting an example method of DMS analysis using a DMS device, in accordance with various examples of the disclosure.

FIG. 7 depicts a block diagram of a computing device.

### DETAILED DESCRIPTION

Aspects of the technology described herein relate to operating a DMS device and a mass spectrometer to identify an unknown compound based on a determined CCS. Example systems and methods analyze a plurality of known compounds with known CCS values and known mass-to-charge ratios (m/z) values using a DMS device. The DMS device is used to determine how the intensities of their transmitted ions vary with a plurality of different SV and CV, and to determine how the intensity of its ions varies with the same plurality of different SVs and CVs. As a result, a data model of the CCS may be established. Examples of the disclosure may predict the identity of an unknown compound from the CCS data model. In various examples, the SV may also be referred to as a dispersion voltage.

A DMS device includes two opposing electrodes which may be, e.g., two parallel flat plates or two opposing curved electrodes. A radio frequency (RF) voltage source may apply an RF SV across the opposing electrodes. A direct current (DC) voltage source may also apply a DC compensation voltage across the opposing electrodes. Unlike traditional ion mobility technologies combined with mass spectrometry (IMS-MS), ions are not separated in time as they traverse a DMS device. Instead, ions are separated in trajectory based on the difference in their mobility between the high field and low field portions of the applied RF voltage source. Any difference between the low-field and high-field mobility of an ion of a compound of interest causes the ion to migrate towards one of the electrodes or plates. The ion may then be steered back towards the center-line of the device by the application of a second voltage offset, which is the CV of the DC voltage source. Ions selected by the combination of SV and CV leave the DMS device to a mass spectrometer. In DMS, a rapidly oscillating electric field that can change by a one or more orders of magnitude is applied to influence the trajectory of a charged molecule. When the ions of each known compound are received by the DMS device, the SV and CV values are ramped in preset increments. For each permutation of SV and CV values, the mass spectrometer measures the m/z and corresponding intensity for all ions transmitted at each permutation. The result is a series of intensity measurements that represent a number of permutations of SV and CV values. From these intensity measurements, a plot of the CV value for each SV value that produces the highest intensity measurement is referred to as a DMS dispersion plot, or alpha curve, may be established, and based on this alpha-curve, a CCS of an unknown compound may be determined. Based on the CCS, the identity of the unknown compound may then be determined.

In other examples, a time-of-flight mass spectrometer (TOF-MS) may also be used, and the TOF-MS may provide the advantage of acquiring additional data such as, e.g., the simultaneous measurement of the mass-to-charge ratios of all ions almost without restriction on the mass range.

Typically, alpha-curves are collected over the entire range of SV voltage such as, e.g., an entire range of 4000 V, with varying increments such as, e.g., increments of 250 V. However, a challenge or technical problem exists in that much of the data requires about 9 data points or more to generate alpha-curves, and are typically collected over a span of several minutes. This approach may be challenging with Liquid Chromatography (LC)-DMS-MS analysis, where compounds may generate a transient signal as the compound elutes from the LC that will be of the order of 6 to 20 seconds. Therefore, collection of alpha-curve data need to occur which a typical cycle spans over a few seconds, e.g., 1 s, 2 s, or 2.5 s.

In various examples, a technical solution to the above technical problem includes acquiring data with alternating SV values, e.g., between two and ten SV values, and repeating the alternating SV values as a cycle over the duration of an LC elution peak. Alternatively, the data may be acquired with alternative SV values, e.g., between two and five or between five and ten. Between each cycle, MS data may be collected while the DMS device is turned off, which enables to derive quantitative information from the data. In examples, by alternating a small number of SV values, e.g., 3 to 6 SV values, or 3 to 8 SV values, at least a part of the alpha-curve may be collected and compared to, e.g., a library of SV-CV curves, to predict the CCS of an unknown compound.

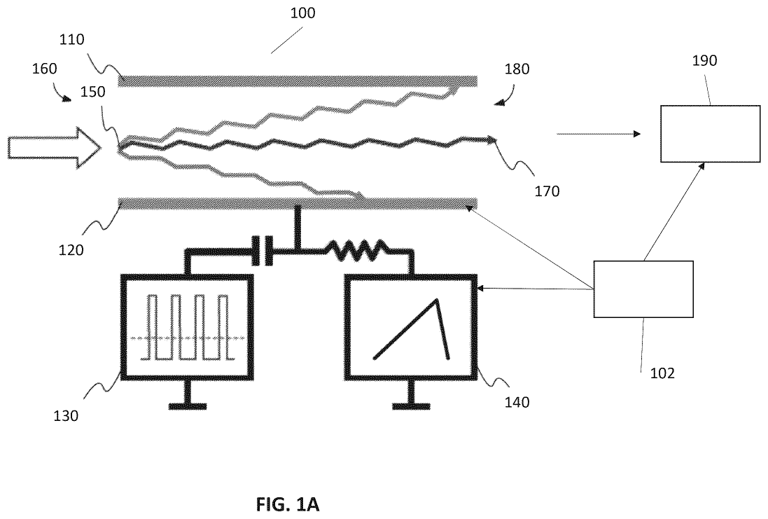

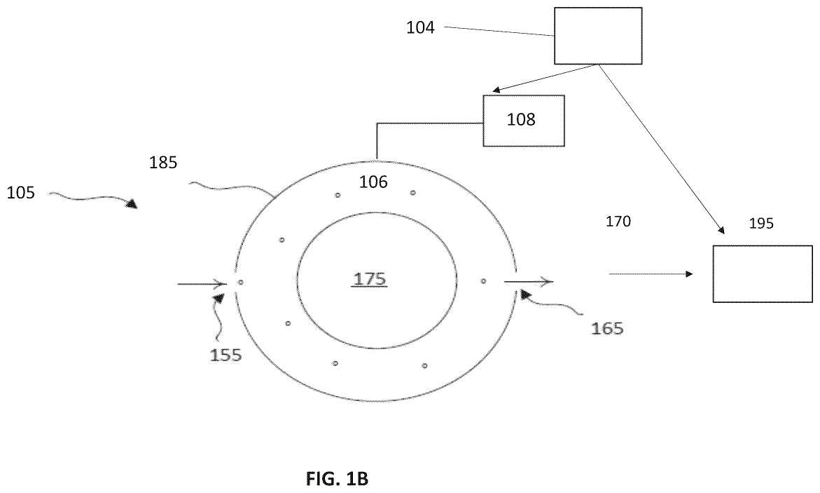

FIGS. 1A and 1B are schematic illustrations of example system DMS devices. In examples, FIG. 1A is a schematic illustration of a DMS device 100 that includes two parallel flat plates 110 and 120. A radio frequency (RF) voltage source 130 is electrically coupled to the plates 110 and 120 and is configured to apply an RF separation voltage (SV) across the plates 110 and 120. A direct current (DC) voltage source 140 is also electrically coupled to the plates 110 and 120, and is configured to apply a DC compensation voltage (CV) across the plates 110 and 120. Ions 150 enter the DMS device 100 in, e.g., a transport gas, via opening 160. The separation of ions 150 in the DMS device 100 due to the application of the SV and the CV is based on, e.g., differences in their respective migration rates under high electric fields versus low electric fields.

Unlike traditional ion mobility, ions 150 are not separated in time as they traverse the device 100. Instead, ions 150 are separated in trajectory based on the difference in their mobility between the high field and low field portions of the applied RF voltage source 130. A high RF field is applied between plates 110 and 120 for a short period of time, and then a low RF field is applied in the opposite direction for, e.g., a longer period of time. Any difference between the low-field and high-field mobility of an ion of a compound of interest causes the ion to migrate towards one of the plates 110 or 120. The ion is steered back towards the center-line of the device by the application of a second voltage offset, known as the CV, of the DC voltage source 140, a compound-specific parameter that may be used to selectively filter out all other ions. Rapid switching of the CV between different CV values allows the user to concurrently monitor many different compounds. The ions 170 selected by the combination of SV and CV leave DMS device 100 through the opening 180 to a mass spectrometer 190.

In general, the DMS device 100 has two modes of operation. In the first mode, the DMS device 100 is on, SV and CV voltages are applied, and ions are separated as a result of passing between the charged plates 110, 120. This is, for example, the enabled mode. In the second mode of operation, the DMS device 100 is off, the SV is set to zero and ions 150 are simply transported from opening 160 to opening 180. This is, for example, the disabled (interrupted SV and CV) or transparent mode of DMS device 100. In the enabled mode, the DMS device 100 can acquire data for a single multiple reaction monitoring (MRM) transition in, e.g., 5 milliseconds (ms) including an inter-scan pause time of, e.g., 7 ms. In the disabled (interrupted SV and CV) or transparent mode, the delay through DMS device 100 may be negligible. In various examples, operation of the DMS device 100 may be controlled by, e.g., a controller or processor 102.

FIG. 1B illustrates a simplified schematic of a Field Asymmetric-waveform Ion-Mobility Spectrometry (FAIMS) DMS 105. The FAIMS DMS 105 includes a pair of curved electrodes 185, 175 that define a curved separation region 106. The FAIMS DMS inlet 155 allows introduction of a transport gas and sample ions into the FAIMS DMS 105 for separation in the curved separation region 106. Sample ions that exhibit mobility that matches the conditions within the curved separation region 106 are allowed to pass through the FAIMS DMS outlet 165. An electrode driving source 108 provides the varying SV and CV to the electrodes 185 and 175. For simplicity, the term DMS will be used herein to refer collectively to both the planar DMS 100, the FAIMS DMS 105, and other similar known differential mobility spectrometer architectures. Similarly to FIG. 1A, the ions selected by the combination of SV and CV in FIG. 1B leave DMS device 105 through the opening 165 to the remainder of the mass spectrometer 195. In various examples, operation of the FAIMS DMS 105 may be controlled by, e.g., a controller or processor 104.

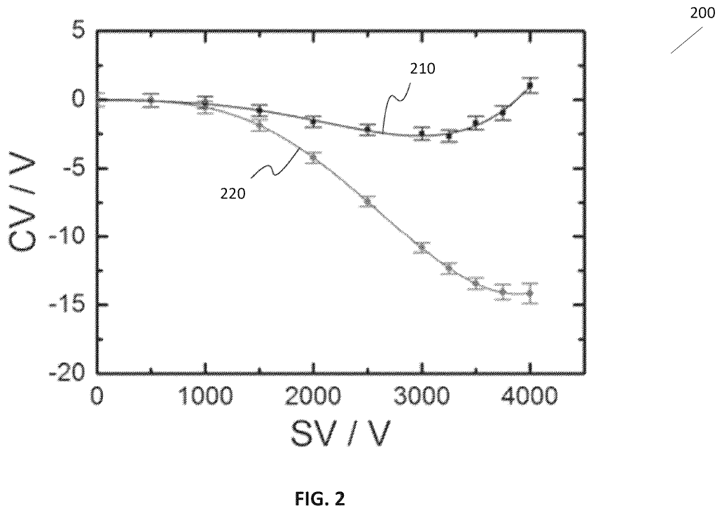

FIG. 2 is an example DMS dispersion plot 200 showing the preferred CV and SV values for ion transmission of two known compounds with different collision cross-sections (CCS). Line 210 is fitted to the preferred CV and SV values of a first compound with a first known CCS. Line 220 is fitted to the preferred CV and SV values of a second compound with a second known CCS. The SV values in FIG. 2 are incrementally increased between 0 and 4,000 Volts, and the corresponding CV values are varied between −15 and 5 Volts. FIG. 2 shows how the correlation of CV values with SV values can vary significantly as the result of different CCS values. Specifically, FIG. 2 shows that the correlation of CV values with SV values changes noticeably for SV values in the range of 1,000 V to 4,000 V due to the differences in CCS values of the compounds.

A sample containing the unknown compound is ionized and transmitted to the DMS device. The compound is unknown in the sense that the CCS of the compound is unknown. The mass-to-charge ratio m/z of the compound may be known or may have been found experimentally, and even the structure of the compound may be known. The elemental formula of the compound may be known, or calculated from the experimental m/z value. When the ions of the unknown compound are received by the DMS device, the SV and CV values are ramped up in preset increments. For each permutation of SV and CV values, the mass spectrometer measures the m/z of the ion of the unknown compound and records their intensity. The result is a series of intensity measurements that represent the plurality of permutations of SV and CV values. From these intensity measurements, only the CV value for each SV value that provides preferred, e.g., highest, transmission of the ion of the known compound is used to determine the CCS value of the unknown compound. The result is a predicted CCS value for the unknown compound.

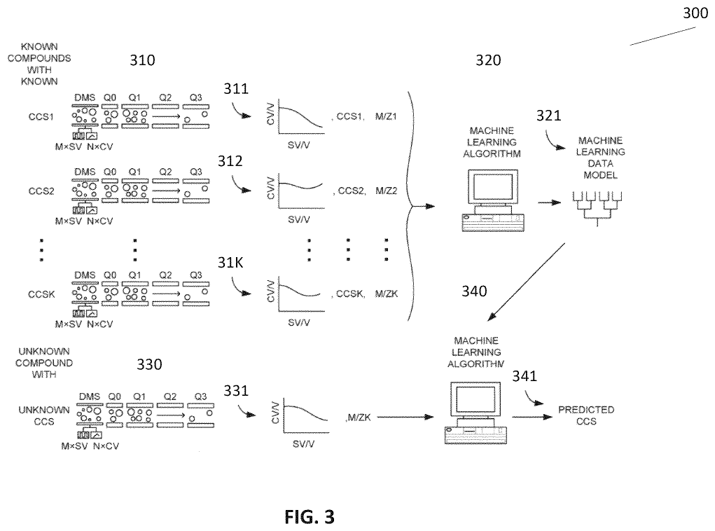

FIG. 3 is a schematic diagram illustrating the process 300 of using DMS measurement data to predict the collision cross-section (CCS) of an unknown compound. In operation 310, a number “K” of compounds with known CCS values are analyzed using a DMS device coupled to a mass spectrometer. For each compound, a number “M” of SV values are stepwise applied to the DMS device and, for each SV value, a number “N” of CV values are stepwise applied to the DMS device. As a result, a total of M×N different voltage combinations are applied, producing M×N separate ion transmissions from the DMS device that are analyzed by the mass spectrometer. For each of the M×N ion transmissions, the mass spectrometer detects the transmitted ion with a known m/z of the known compound and measures the intensity of the selected ion. This produces M×N intensity measurements. These measurements are further refined to determine the correlation between CV and SV values for improved ion transmission.

For example, a CV value for each of the “M” SV values that resulted in the highest intensity is selected. This produces “M” pairs of CV and SV values that resulted in the highest intensity. In FIG. 3, these “M” pairs of CV and SV values that resulted in the highest intensity for each of the “K” known compounds, “K” representing the number of known compounds, are represented by dispersion plots 311, 312, . . . 31K. In operation 320, the known CCS value, m/z value, and measured “M” pairs of CV and SV values for each of the “K” known compounds 311, 312, . . . , 31K are provided as input, and a data model 321, e.g., a machine learning model, may be generated from this data.

In operation 330, a compound with an unknown CCS value is analyzed using a DMS device coupled to a mass spectrometer. The same “M” SV values are stepwise applied to the DMS device and, for each SV value, the same “N” CV values are stepwise applied to the DMS device. As a result, M×N different voltage combinations are applied, producing M×N separate ion transmissions from the DMS device that are analyzed by the mass spectrometer. For each of the M×N ion transmissions, the mass spectrometer detects the transmitted ion with a known m/z of the unknown compound and measures the intensity of the transmitted ion. This produces M×N intensity measurements. These measurements are also further refined to determine the correlation between CV and SV values for improved ion transmission. A CV value for each of the “M” SV values that resulted in the highest intensity is selected. This produces “M” pairs of CV and SV values that resulted in the highest intensity. In FIG. 3, these “M” pairs of CV and SV values that resulted in the highest intensity for the unknown compound are represented by dispersion plot 331. In operation 340, the known m/z value and measured “M” pairs of CV and SV values for the unknown compound 331 are provided as inputs to data model 321. From these inputs, data model 321 predicts CCS value 341 for the unknown compound. Accordingly, a CCS value of an unknown compound may be predicted based on measurement data from compounds with a range of different CCS values. Based on the predicted CCS value, the identity of the unknown compound may be established.

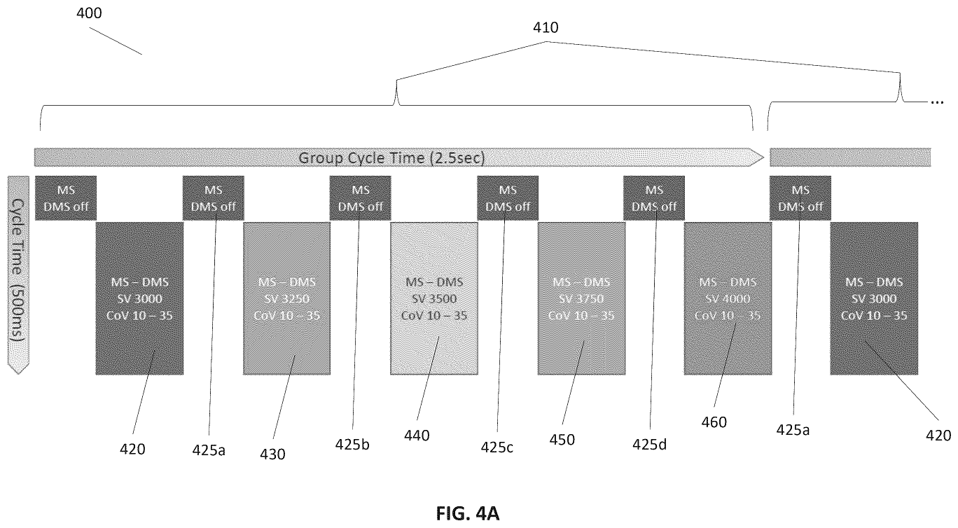

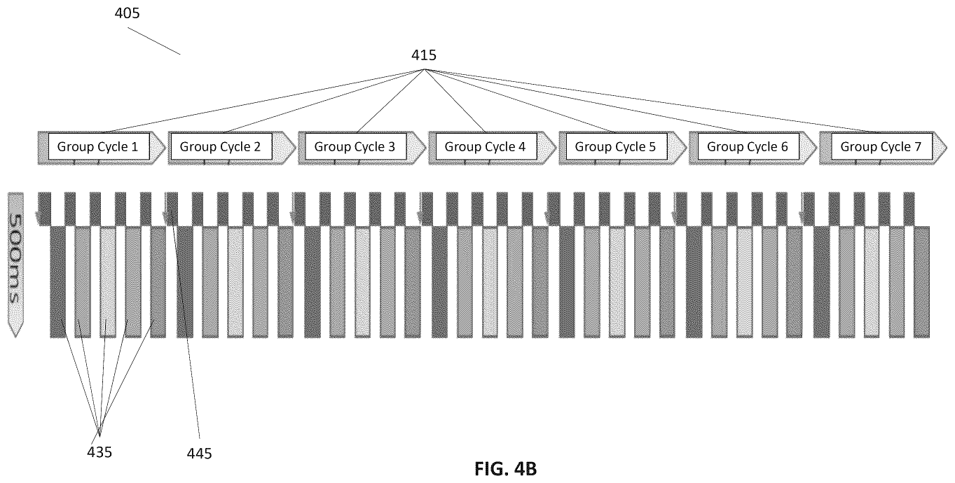

FIGS. 4A and 4B illustrate a method of DMS analysis using a DMS device, according to various examples of the disclosure. In various examples, the method 400 illustrated in FIG. 4A includes a plurality of cycles 410, each cycle 410 including a plurality of operations. For example, within a given cycle 410, the method includes, after introducing a sample at an opening of the DMS device, applying a SV and a range of compensation voltages (CV), as described above with respect to FIG. 3, during operation 420. For example, the SV is 3000 V and the CV values are in a range of 10 V to 35 V. For example, a plurality of CV are applied corresponding to the SV value of 3000 V. In various examples, a first CV of 10 V may be applied, and during operation 425a, both the SV and CV are turned off and a MS scan is performed on the ions exiting the DMS device. Then the same SV of 3000 V is applied and another CV, e.g., of 10 V, is applied. Then both the SV and CV are turned off as the ion exits the DMS device and another MS scan is performed during operation 425a. In examples, the same operations are performed where incrementally higher CV are applied, e.g., 15 V, 20 V, 25 V, 30 V and 35 V, and a MS scan is performed, for each CV and for the same SV of 3000 V, on the ion exiting the DMS device, after both the SV and the CV are turned off during operation 425a.

Accordingly, in various examples, once the SV and all the corresponding CV values have been applied during operation 420 and each MS scan is performed during operation 425a, similar operations are repeated with incrementally increasing SV values within the same group cycle 410. For example, during operation 430 which follows operation 420, a different SV is applied to the sample introduced into the DMS device, as well as a corresponding range of CV values. For example, if an SV of 3000 V is applied during operation 420, then an SV of 3250 V may be applied during operation 430, and the corresponding CV values that are applied are in a range of 10 to 35 V, e.g., 10 V. Then both the SV and CV are turned off as the ion exits the DMS device and a MS scan is performed during operation 425b. In examples, the same operations are performed where incrementally higher CV are applied, e.g., 15 V, 20 V, 25 V, 30 V and 35 V, and a MS scan is performed, for each CV and the SV of 3250 V, on the ion exiting the DMS after both the SV and the CV are turned off during operation 425b.

In various examples, during operation 440, a SV that is incrementally higher than the SV applied during operation 430, and a corresponding range of CV values, are applied. For example, the SV applied during operation 440 is equal to 3500 V, and the corresponding CV that are applied are in a range of 10 to 35 V. In other examples, once the SV and a corresponding CV, e.g., 10 V, have been applied during operation 440, for each applied CV, the SV and CV are turned off and a MS scan is performed on the ion exiting the DMS device during operation 425c. In examples, similar operations are performed for each applied CV, e.g., 15 V, 20 V, 25 V, 30 V and 35 V, and a MS scan is performed, for each CV and the SV of 3500 V, on the ion exiting the DMS after both the SV and the CV are turned off during operation 425c.

In other examples, during operation 450, a SV that is incrementally higher than the SV applied during operation 440, and a corresponding range of CV values, are applied. For example, the applied SV is equal to 3750 V, and the corresponding CV is in a range of 10 to 35 V. In other examples, once the SV and corresponding CV, e.g., 10 V, have been applied during operation 450, for each applied CV, the SV and CV are turned off and a MS scan is performed on the ions exiting the DMS device during operation 425d. In yet other examples, during operation 460, a SV that is incrementally higher than the SV applied during operation 450, and a corresponding range of CV values, are applied. For example, the SV is 4000 V, and the corresponding CV is in a range of 10 to 35 V. In other examples, once the SV and corresponding CV have been applied during operation 460, for each applied CV, the SV and CV are turned off and a MS scan is performed on the ions exiting the DMS device. In various examples, once operation 460 has been performed, the cycle 410 has been completed and, e.g., another cycle may start, as further discussed below with respect to FIG. 4B. In examples, the MS scan may be a single MS scan, and may be an MS/MS scan, or may be both. In another example, the MS scan may be performed at a predetermined frequency, e.g., a frequency of 2 Hz. In examples, the MS/MS may include data-independent acquisition (DIA), e.g., via a SWATH™ acquisition. In other examples, the MS scan may be performed at a frequency ranging between 1 Hz and 3 Hz.

In various examples, the applied SV are RF separation voltages, and may be RF separation voltages of different frequencies. For example, the RF separation voltages may be or include voltages generating a combined asymmetric waveform. In an example, more than two SV may be applied. In other examples, two to twenty SV may be applied. As a DMS device can accommodate a maximum allowable range of voltages, in various examples, the applied SV may span the entire maximum allowable range of voltages of the DMS device. In other examples, the applied SV may span a sub-range allowable range of voltages of the DMS device such as, e.g., the second half of the maximum number of voltages allowable in the DMS device. In various examples, the applied SV range up to 4200 V. In another example, the applied SV may range from 2100 V to 4200 V. In other example, the applied SV may be centered around a value of 3000 V. In yet other example, the applied SV are discrete incremental SV, and may be separated by a fixed increment. For example, two successively applied SV may be separated by an increment in a range of 50 V to 250 V. As an example, if an applied SV is equal to 2200 V, then the subsequently applied SV may be equal to 2400 V, and the voltage increment in this case is 200 V.

In other examples, the applied CV are also applied within a range. For example, the range of applied CV may be 10 V to 35 V. Accordingly, for each applied SV, several CV are applied, e.g., 10 V, 15 V, 20 V, 25 V, 30 V and 35 V, and for each applied CV, the ion exiting the DMS device undergoes an MS scan. Based on the MS scans performed for each CV corresponding to the same SV, the most preferred CV, i.e., the CV for which the MS scan produced the highest intensity, is selected. In examples, the applied CV are DC voltages. In addition, although FIG. 4A illustrates five (5) SV application cycles 420-460, various examples include the application of SV 3 or more times, or the application of SV 3 to 15 times.

In various examples, the method 405 illustrated in FIG. 4B includes a plurality of cycles 415, and each cycle 415, referred to in the figure as “Group Cycle,” includes a plurality of operations such as, e.g., the plurality of operations 420-460 and 425a-425d described above with respect to in FIG. 4A. For example, each group cycle 415 may be performed over a predetermined period of time, and the predetermined period of time may correspond to the elution time associated with a chromatography peak. In various examples, operations 435 include setting incrementally increasing SV values and, for each SV value, applied incrementally increasing corresponding CV values, similarly to steps 420-460 discussed above with respect to FIG. 4A. In examples, operations 435 includes turning off SV and corresponding CV for each applied CV, and performing an MS scan on the ion exiting the DMS device, between each one of operations 435. In examples, each of the group cycles 415 illustrated in FIG. 4B may correspond to the cycle 410 described above with respect to FIG. 4A, and the group cycles 415 may be repeated a number of times, e.g., up to 10 times. In various examples, each group cycle 415 may correspond to a different analyte or compound.

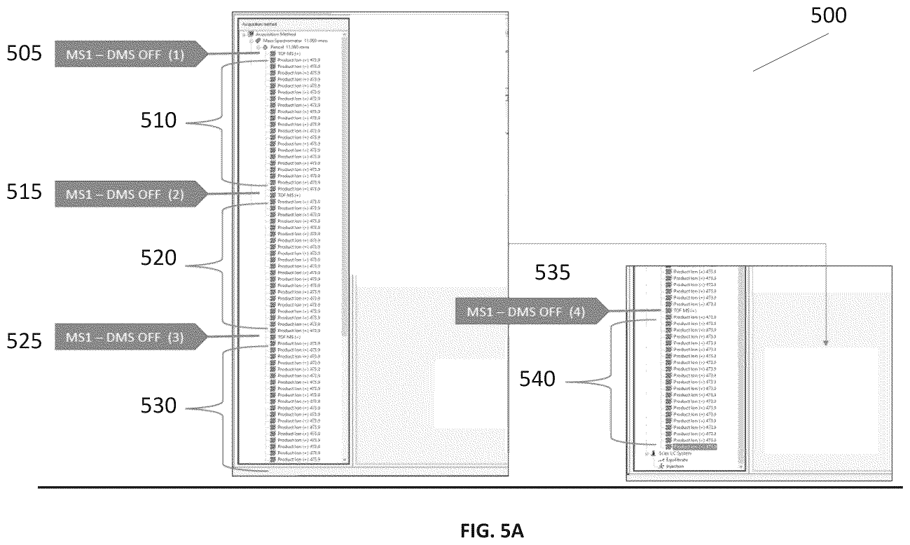

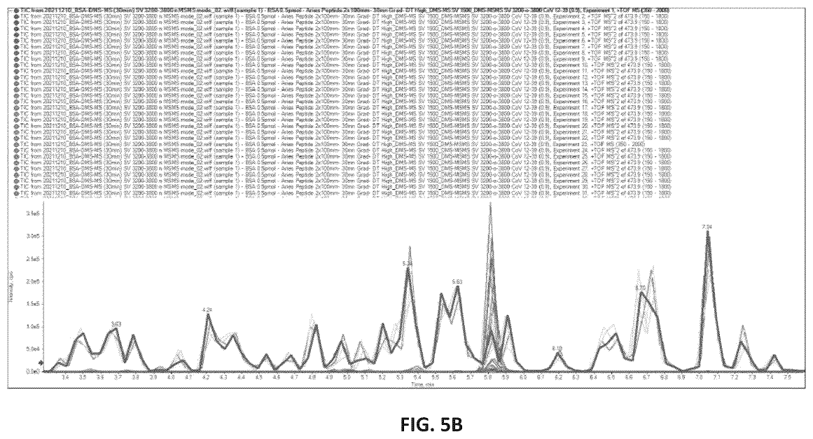

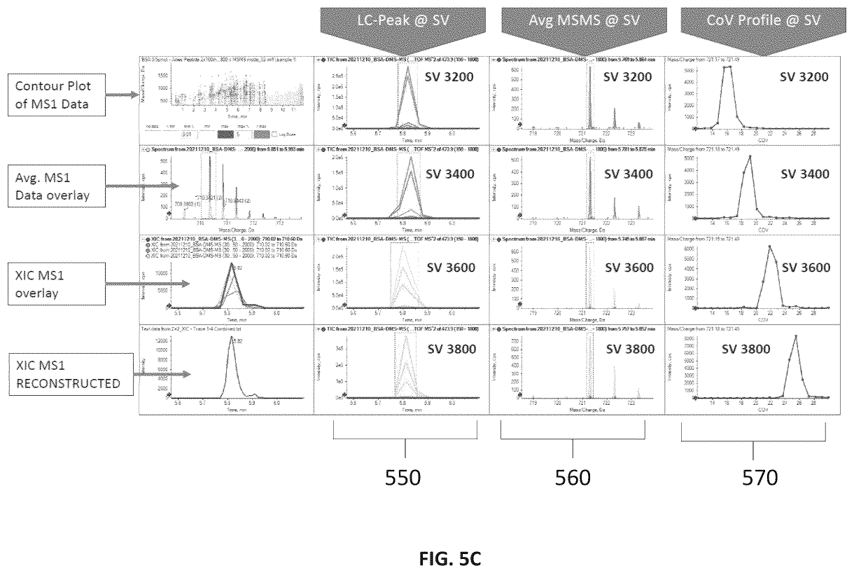

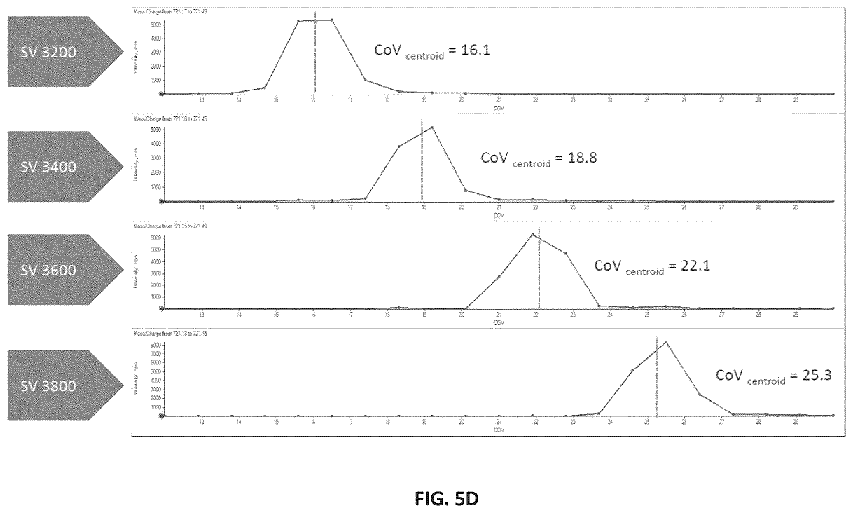

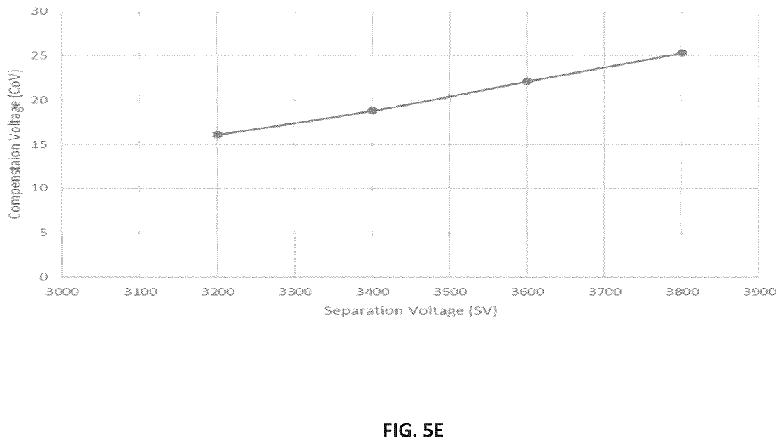

FIGS. 5A-5E depict data collection and analysis 500 using a DMS device, according to various examples of the disclosure. In FIG. 5A, the data collection 500 starts with an MS scan 505 being performed with the DMS device being turned off, followed by applying a SV 510 at 3200 V and CV in a range of 12-30V, and subsequently turning off the DMS and performing an MS scan 515. The analysis 500 further include applying a SV 520 at 3400V and a CV in a range of 12-30 V, and subsequently turning off the DMS and performing an MS scan 525. In examples, the data collection 500 may also include applying a SV 530 at 3600 V and CV in a range of 12-30V, and subsequently turning off the DMS and performing an MS scan 535. In other examples, the data collection 500 may further include applying a SV 540 at 3800 V and CV in a range of 12-30V. Accordingly, in the examples illustrated in FIG. 5A, the SV incrementally increases between cycles by 200 V.

FIG. 5B illustrates an overlay of all experimental traces collected over time, in accordance with various examples. In the examples illustrated in FIGS. 5B, 88 experiments have been conducted including 5 MS scans and 83 MS/MS scans at four (4) different SV values. The graph in FIG. 5B illustrates the measured intensity with respect to time.

FIG. 5C illustrates a plurality of graphs describing the collection, analysis and extraction of a DMS/MS data, according to various examples of the disclosure. In examples, the graphs in column 550 illustrate the elution chromatography peak at SV values ranging from 3200 V to 3800 V with a 200 V voltage increment therebetween. In columns 550, the data is collected in terms of intensity with respect to time. In other examples, the graphs in column 560 illustrate the mass-to-charge (m/z) ratios derived from the graphs in column 550 for the SV values ranging from 3200 V to 3800 V. In yet other examples, the graphs in column 570 illustrate the range of CV values, identified as “CoV” in the graphs, defining an preferred CV for each SV value. In examples, the CV value for which the measured intensity is optimal or preferred, i.e., corresponds to the highest measured intensity, is used for compensation of the ion path through the DMS device, and is used for the determination of the CCS of, e.g., an unknown compound, as further discussed below with respect to FIG. 5D. In column 570, the preferred CV value can be determined as the centroid of the curve.

FIG. 5D illustrates the determination of the optimal or preferred, e.g., highest, CV value for each SV, in accordance with various examples of the disclosure. In examples, for each combination of SV and CV, the resulting intensity is measured and plotted on a CV scale. Accordingly, the preferred CV for each SV may be determined as the centroid of each curve. For example, as illustrated in FIG. 5D, the preferred CV for the 3200 V SV is equal to 16.1 V, for the 3400 V SV is equal to 18.8 V, for the 3600 V SV is equal to 22.1 V, and for the 3900 V SV is equal to 25.3 V. In various examples, each of the SV values and their corresponding preferred CV values, may be considered together to determine the CCS of an unknown compound. FIG. 5E illustrates a curve, also referred to as alpha-curve, plotting the preferred CV value for each SV. As discussed above with respect to FIG. 2, based on the plot illustrated in FIG. 5E, the CCS of an unknown compound may be determined, and based on the determined CCS, the identity of the unknown compound may be established.

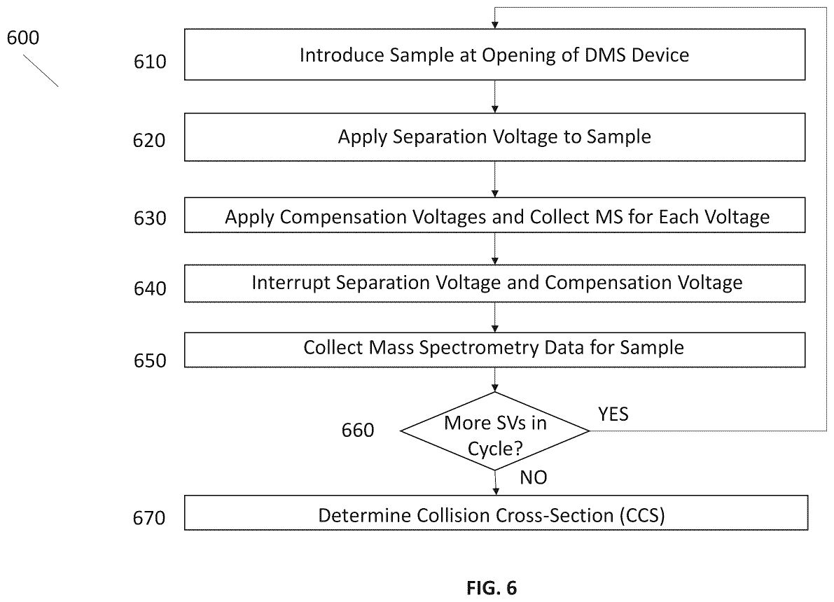

FIG. 6 is a flow chart depicting an example method of differential mobility spectrometry (DMS) analysis using a DMS device, in accordance with various examples of the disclosure. For example, the method 600 is described through use of the example systems 100 or 105 described above.

In various examples, operation 610 includes introducing a sample in an opening of a DMS device. With reference to FIG. 1A or 1B, the ions 150 may be introduced at opening 160 or inlet 155 into the DMS device 100 or the FAIMS DMS 105. During operation 620, the method 600 includes applying a separation voltage (SV) to the ions. With reference to FIG. 1A or 1B, the SV may be applied between the planar electrodes 110 and 120 of the DMS 100, or between the curved electrodes 175 and 185 of the FAIMS DMS 105, to the introduced ions. In other examples, operation 630 includes applying a range of CV values to the introduced sample, and collected the MS data for each applied CV value. With reference to FIG. 1A or 1B, the CV may be applied across the planar electrodes 110 and 120 of the DMS 100, or across the curved electrodes 175 and 185 of the FAIMS DMS 105, to the introduced ions.

In various examples, during operation 640, the method 600 includes, after each applied CV, interrupting, or turning off, both the SV and the CV, and during operation 650, the method 600 includes subsequently collecting mass spectrometry data for the sample by performing a MS or MS/MS scan on the sample. With reference to FIG. 1A or 1B, the ions that leave the DMS device 100 from opening 180, or the FAIMS DMS device 105 from the outlet 165, may be transferred to a MS device such as MS device 190 or 195. In various examples, operations 630, 640 and 650 are repeated for each of the plurality of CV that are applied to compensate for the SV that was applied during operation 620, and after each applied CV, both the SV and the CV are interrupted, and mass spectrometry is performed on the sample exiting the DMS device during operation 650.

In various examples, operation 660 includes determining whether there are other SV values to be applied to the sample. When operation 660 determines that another SV is to be applied to the sample, then during operation 610, another sample, identical to the sample first introduced into the DMS device, is introduced in the DMS device. When operation 660 determines that no other SV is to be applied to the sample, then during operation 670, the CCS value for the sample is determined. In various examples, in order for the CCS value to be determined, the preferred CV for each applied SV is determined out of the range of CV applied, and a relationship between the SV and the optimum CV is established. It is based on this relationship that the CCS value for the sample is determined. In various examples, on the basis of the determined CCS, it may be possible to identify an unknown compound by, e.g., comparing the determined CCS value with a library of SV-CV curves, or by comparing the determined CCS value with a model. In examples, the unknown compound may be identified based on modeling, e.g., based on a model trained to identify one or more compounds on the basis of the determined CCS value.

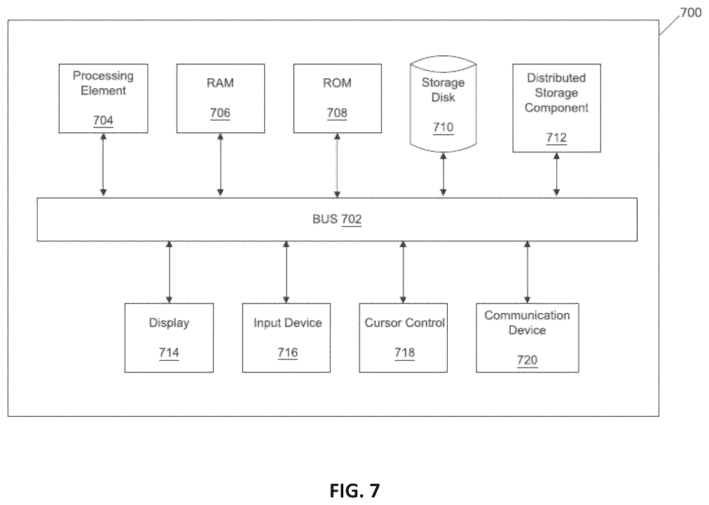

FIG. 7 depicts a block diagram of a computing device that may be used to control operation of, e.g., the systems 100 and 105 discussed above with respect to FIGS. 1A and 1B. In the illustrated example, the computing device 700, e.g., similar to the controller or processors 102 and 104 discussed above, may include a bus 702 or other communication mechanism of similar function for communicating information, and at least one processing element 704 (collectively referred to as processing element 704) coupled with bus 702 for processing information. As will be appreciated by those skilled in the art, the processing element 704 may include a plurality of processing elements or cores, which may be packaged as a single processor or in a distributed arrangement. Furthermore, a plurality of virtual processing elements 704 may be included in the computing device 700 to provide the control or management operations for, e.g., the systems 100 and 105 illustrated above.

The computing device 700 may also include one or more volatile memory(ies) 706, which can for example include random access memory(ies) (RAM) or other dynamic memory component(s), coupled to one or more busses 702 for use by the at least one processing element 704. Computing device 700 may further include static, non-volatile memory(ies) 708, such as read only memory (ROM) or other static memory components, coupled to busses 702 for storing information and instructions for use by the at least one processing element 704. A storage component 710, such as a storage disk or storage memory, may be provided for storing information and instructions for use by the at least one processing element 704. As will be appreciated, the computing device 700 may include a distributed storage component 712, such as a networked disk or other storage resource available to the computing device 700.

The computing device 700 may be coupled to one or more displays 714 for displaying information to a user. Optional user input device(s) 716, such as a keyboard and/or touchscreen, may be coupled to Bus 702 for communicating information and command selections to the at least one processing element 704. An optional cursor control or graphical input device 718, such as a mouse, a trackball or cursor direction keys for communicating graphical user interface information and command selections to the at least one processing element. The computing device 700 may further include an input/output (I/O) component, such as a serial connection, digital connection, network connection, or other input/output component for allowing intercommunication with other computing components and the various components of, e.g., the systems 100 and 105 discussed above.

In various examples, computing device 700 can be connected to one or more other computer systems via a network to form a networked system. Such networks can for example include one or more private networks or public networks, such as the Internet. In the networked system, one or more computer systems can store and serve the data to other computer systems. The one or more computer systems that store and serve the data can be referred to as servers or the cloud in a cloud computing scenario. The one or more computer systems can include one or more web servers, for example. The other computer systems that send and receive data to and from the servers or the cloud can be referred to as client or cloud devices, for example. Various operations of, e.g., the systems 100 and 105 may be supported by operation of the distributed computing systems.

The processors or controllers 102 and 104 discussed above with respect to FIGS. 1A-1B, similar to the computing device 700, may be operative to control operation of the components of the systems 100 and 105 through a communication device such as, e.g., communication device 720, and to handle data generated by components of the systems 100 and 105. In some examples, analysis results are provided by the computing device 700 in response to the at least one processing element 704 executing instructions contained in memory 706 or 708 and performing operations on data received from the systems 100 and 105. Execution of instructions contained in memory 706 and/or 708 by the at least one processing element 704 can render, e.g., the systems 100 and 105 and associated sample delivery components operative to perform methods described herein.

The term “computer-readable medium” as used herein refers to any media that participates in providing instructions to the processing element 704 for execution. Such a medium may take many forms, including but not limited to, non-volatile media, volatile media, and transmission media. Non-volatile media includes, for example, optical or magnetic disks, such as disk storage 710. Volatile media includes dynamic memory, such as memory 706. Transmission media includes coaxial cables, copper wire, and fiber optics, including the wires that include bus 702.

Common forms of computer-readable media or computer program products include, for example, a floppy disk, a flexible disk, hard disk, magnetic tape, or any other magnetic medium, a CD-ROM, digital video disc (DVD), a Blu-ray Disc, any other optical medium, a thumb drive, a memory card, a RAM, PROM, and EPROM, a FLASH-EPROM, any other memory chip or cartridge, or any other tangible medium from which a computer can read.

Various forms of computer readable media may be involved in carrying one or more sequences of one or more instructions to the processing element 704 for execution. For example, the instructions may initially be carried on the magnetic disk of a remote computer. The remote computer can load the instructions into its dynamic memory and send the instructions over a telephone line using a modem. A modem local to computing device 700 can receive the data on the telephone line and use an infra-red transmitter to convert the data to an infra-red signal. An infra-red detector coupled to bus 702 can receive the data carried in the infra-red signal and place the data on bus 702. Bus 702 carries the data to memory 706, from which the processing element 704 retrieves and executes the instructions. The instructions received by memory 706 and/or memory 708 may optionally be stored on storage device 710 either before or after execution by the processing element 704.

In accordance with various examples, instructions operative to be executed by a processing element to perform a method are stored on a computer-readable medium. The computer-readable medium can be a device that stores digital information. For example, a computer-readable medium includes a compact disc read-only memory (CD-ROM) as is known in the art for storing software. The computer-readable medium is accessed by a processor suitable for executing instructions configured to be executed.

Various examples of the disclosure include the following clauses:
Clause 1: A method of differential mobility spectrometry (DMS) analysis using a DMS device, the method including: introducing a sample at an opening of the DMS device; sequentially applying a plurality of separation voltages between opposing electrodes of the DMS device, wherein sequentially applying the plurality of separation voltages includes, for each applied separation voltage: applying a plurality of incrementally increasing compensation voltages between the opposing electrodes of the DMS device; following each applied compensation voltage: interrupting application of the separation voltage and of the compensation voltage; and collecting mass spectrometry (MS) data for the sample exiting the DMS device while the separation voltage and the compensation voltage are interrupted; and determining an optimum compensation voltage out of the plurality of compensation voltages based on the collected MS data; repeating the sequentially applying of the plurality of separation voltages to the introduced sample a plurality of times; and determining a collision cross-section (CCS) value for the sample based on the applied separation voltages and their corresponding determined optimum compensation voltages variation as a function of the applied separation voltages.
Clause 2: The method of clause 1, wherein sequentially applying the plurality of separation voltages includes sequentially applying a plurality of RF separation voltages.
Clause 3: The method of clause 1 or clause 2, wherein the RF separation voltages include voltages of different frequencies.
Clause 4: The method of any one of clauses 1-3, wherein the RF separation voltages include voltages generating a combined asymmetric waveform.
Clause 5: The method of any one of clauses 1-4, wherein the sequentially applying the plurality of separation voltages includes sequentially applying more than two separation voltages.
Clause 6: The method of any one of clauses 1-5, wherein the sequentially applying the plurality of separation voltages includes sequentially applying two to twenty separation voltages.
Clause 7: The method of any one of clauses 1-6, wherein sequentially applying the plurality of separation voltages includes sequentially applying the plurality of separation voltages over a maximum range of voltages allowable in the DMS device.
Clause 8: The method of any one of clauses 1-7, wherein sequentially applying the plurality of separation voltages includes sequentially applying the plurality of separation voltages over a sub-range of a maximum number of voltages in the DMS device.
Clause 9: The method of any one of clauses 1-8, wherein the sub-range of the maximum number of voltages is a second half of the maximum range of voltages allowable in the DMS device.
Clause 10: The method of any one of clauses 1-9, wherein the sub-range of the maximum number of voltages is centered around a mid-point between half the maximum range and the maximum range of voltages allowable in the DMS device.
Clause 11: The method of any one of clauses 1-10, wherein sequentially applying the plurality of separation voltages includes sequentially applying the plurality of separation voltages over a range of up to 4200 V.
Clause 12: The method of any one of clauses 1-11, wherein sequentially applying the plurality of separation voltages includes sequentially applying the plurality of separation voltages over a range of 2100 V to 4200 V.
Clause 13: The method of any one of clauses 1-12, wherein sequentially applying the plurality of separation voltages includes sequentially applying the plurality of separation voltages that are centered around 3000 V.
Clause 14: The method of any one of clauses 1-13, wherein sequentially applying the plurality of separation voltages includes sequentially applying discrete incremental separation voltages.
Clause 15: The method of any one of clauses 1-14, wherein sequentially applying discrete incremental separation voltages includes applying separation voltages separated by a voltage increment in a range of 50 V to 250 V.
Clause 16: The method of any one of clauses 1-15, wherein: the opposing electrodes of the DMS device are opposing planar electrodes; and sequentially applying the plurality of separation voltages includes sequentially applying the plurality of separation voltages between the opposing planar electrodes.
Clause 17: The method of any one of clauses 1-16, wherein: the opposing electrodes of the DMS device are opposing curved electrodes; and sequentially applying the plurality of separation voltages includes sequentially applying the plurality of separation voltages between the opposing curved electrodes.
Clause 18: The method of any one of clauses 1-17, wherein applying the plurality of incrementally increasing compensation voltages includes applying a plurality of incrementally increasing DC compensation voltages.
Clause 19: The method of any one of clauses 1-18, wherein collecting the MS data includes performing a single MS scan.
Clause 20: The method of any one of clauses 1-19, wherein collecting the MS data includes performing an MS/MS scan.
Clause 21: The method of any one of clauses 1-20, wherein collecting the MS data is performed at a frequency of 2 Hz.
Clause 22: The method of any one of clauses 1-21, wherein repeating the sequentially applying the plurality of separation voltages is performed over a predetermined period of time.
Clause 23: The method of any one of clauses 1-22, wherein the predetermined period of time corresponds to an elution time associated with a chromatography peak.
Clause 24: The method of any one of clauses 1-23, wherein repeating the sequentially applying the plurality of separation voltages includes sequentially applying the plurality of separation voltages 3 or more times.
Clause 25: The method of any one of clauses 1-24, wherein repeating the sequentially applying the plurality of separation voltages includes sequentially applying the plurality of separation voltages 3 to 15 times.
Clause 26: The method of any one of clauses 1-25, further including identifying one or more compounds present in the sample based on the determined CCS value.
Clause 27: The method of any one of clauses 1-26, wherein identifying the one or more compounds includes comparing the determined CCS value with contents of a library of SV-CV curves.
Clause 28: The method of any one of clauses 1-27, wherein identifying the one or more compounds includes modeling the determined CCS value.
Clause 29: A system of differential mobility spectrometry (DMS), the system including: a sample input device; a DMS device fluidically coupled to the sample input device; a DC voltage source; an RF voltage source; a mass analysis device; a processor operatively coupled to the DMS device, the DC voltage source, the RF voltage source and the mass analysis device; and a memory coupled to the processor, the memory storing instructions that, when executed by the processor, perform a set of operations including: introducing, via the sample input device, a sample at an opening of the DMS device; sequentially applying, via the RF voltage source, a plurality of separation voltages between opposing electrodes of the DMS device, wherein sequentially applying the plurality of separation voltages includes, for each applied separation voltage: applying, via the DC voltage source, a plurality of incrementally increasing compensation voltages between the opposing electrodes of the DMS device; following each applied compensation voltage: interrupting, via the processor, application of the separation voltage and of the compensation voltage; and collecting, via the processor and the mass analysis device, mass spectrometry (MS) data for the sample exiting the DMS device while the separation voltage and the compensation voltage are interrupted; and determining, via the processor, an optimum compensation voltage out of the plurality of compensation voltages based on the collected MS data; repeating, via the processor, the sequentially applying the plurality of separation voltages to the introduced sample a plurality of times; and determining, via the processor, a collision cross-section (CCS) value for the sample based on the applied separation voltages and their corresponding determined optimum compensation voltages variation as a function of the applied separation voltages.
Clause 30: The system of clause 29, wherein the set of instructions further includes sequentially applying the plurality of separation voltages by sequentially applying a plurality of RF separation voltages.
Clause 31: The system of clause 29 or clause 30, wherein the RF separation voltages include voltages of different frequencies.
Clause 32: The system of any one of clauses 29-31, wherein the RF separation voltages include voltages generating a combined asymmetric waveform.
Clause 33: The system of any one of clauses 29-32, wherein the set of instructions further includes sequentially applying the plurality of separation voltages by sequentially applying more than two separation voltages.
Clause 34: The system of any one of clauses 29-33, wherein the set of instructions further includes sequentially applying the plurality of separation voltages by sequentially applying 2 to 20 separation voltages.
Clause 35: The system of any one of clauses 29-34, wherein the set of instructions further includes sequentially applying the plurality of separation voltages by sequentially applying the plurality of separation voltages over a maximum range of voltages allowable in the DMS device.
Clause 36: The system of any one of clauses 29-35, wherein the set of instructions further includes sequentially applying the plurality of separation voltages by sequentially applying the plurality of separation voltages over a sub-range of a maximum number of voltages allowable in the DMS device.
Clause 37: The system of any one of clauses 29-36, wherein the sub-range of the maximum number of voltages is a second half of the maximum number of voltages allowable in the DMS device.
Clause 38: The system of any one of clauses 29-37, wherein the sub-range of the maximum number of voltages is centered around a mid-point between half the maximum range and the maximum range of voltages allowable in the DMS device.
Clause 39: The system of any one of clauses 29-38, wherein the set of instructions further includes sequentially applying the plurality of separation voltages by sequentially applying the plurality of separation voltages over a range of 0 V to 4200 V.
Clause 40: The system of any one of clauses 29-39, wherein the set of instructions further includes sequentially applying the plurality of separation voltages by sequentially applying the plurality of separation voltages over a range of 2100 V to 4200 V.
Clause 41: The system of any one of clauses 29-40, wherein the set of instructions further includes sequentially applying the plurality of separation voltages by sequentially applying discrete incremental separation voltages.
Clause 42: The system of any one of clauses 29-41, wherein the set of instructions further includes sequentially applying discrete incremental separation voltages separated by a voltage increment in a range of 50 V to 250 V.
Clause 43: The system of any one of clauses 29-42, wherein: the opposing electrodes of the DMS device are opposing planar electrodes; and the set of instructions further includes sequentially applying the plurality of separation voltages by sequentially applying the plurality of separation voltages between the opposing planar electrodes.
Clause 44: The system of any one of clauses 29-43, wherein: the opposing electrodes of the DMS device are opposing curved electrodes; and the set of instructions further includes sequentially applying the plurality of separation voltages by sequentially applying the plurality of separation voltages between the opposing curved electrodes.
Clause 45: The system of any one of clauses 29-44, wherein the set of instructions further includes applying the plurality of incrementally increasing compensation voltages by applying a plurality of incrementally increasing DC compensation voltages.
Clause 46: The system of any one of clauses 29-45, wherein the set of instructions further includes collecting the MS data by performing a single MS scan.
Clause 47: The system of any one of clauses 29-46, wherein the set of instructions further includes collecting the MS data by performing an MS/MS scan.
Clause 48: The system of any one of clauses 29-47, wherein the set of instructions further includes collecting the MS data at a frequency of 2 Hz.
Clause 49: The system of any one of clauses 29-48, wherein the set of instructions further includes repeating the sequentially applying the plurality of separation voltages over a predetermined period of time.
Clause 50: The system of any one of clauses 29-49, wherein the predetermined period of time corresponds to an elution time associated with a chromatography peak.
Clause 51: The system of any one of clauses 29-50, wherein the set of instructions further includes repeating the sequentially applying the plurality of separation voltages 3 or more times.
Clause 52: The system of any one of clauses 29-51, wherein the set of instructions further includes repeating the sequentially applying the plurality of separation voltages 3 to 15 times.
Clause 53: The system of any one of clauses 29-52, wherein the set of instructions further includes identifying one or more compounds present in the sample based on the determined CCS value.
Clause 54: The system of any one of clauses 29-53, wherein the set of instructions includes identifying the one or more compounds based on a comparison of the determined CCS value with contents of a library of SV-CV curves.
Clause 55: The system of any one of clauses 29-54, wherein the set of instructions includes identifying the one or more compounds based on modeling of the determined CCS value.
Clause 56: The system of any one of clauses 29-55, wherein the set of instructions includes identifying the one or more compounds based on a partial alpha-curve function derived from an SV-CV curve and compared to a library of alpha-curve function.

This disclosure described some examples of the present technology with reference to the accompanying drawings, in which only some of the possible examples were shown. Other aspects can, however, be embodied in many different forms and should not be construed as limited to the examples set forth herein. Rather, these examples were provided so that this disclosure was thorough and complete and fully conveyed the scope of the possible examples to those skilled in the art.

Although specific examples were described herein, the scope of the technology is not limited to those specific examples. One skilled in the art will recognize other examples or improvements that are within the scope of the present technology. Therefore, the specific structure, acts, or media are disclosed only as illustrative examples. Examples according to the technology may also combine elements or components of those that are disclosed in general but not expressly exemplified in combination, unless otherwise stated herein. The scope of the technology is defined by the following claims and any equivalents therein.

What is claimed is:

1. A method of differential mobility spectrometry (DMS) analysis using a DMS device, the method comprising:
introducing a sample at an opening of the DMS device;
sequentially applying a plurality of separation voltages between opposing electrodes of the DMS device, wherein sequentially applying the plurality of separation voltages comprises, for each applied separation voltage:
applying a plurality of incrementally increasing compensation voltages between the opposing electrodes of the DMS device;
following each applied compensation voltage:
interrupting application of the separation voltage and of the compensation voltage; and
collecting mass spectrometry (MS) data for the sample exiting the DMS device while the separation voltage and the compensation voltage are interrupted; and
determining an optimum compensation voltage out of the plurality of compensation voltages based on the collected MS data;
repeating the sequentially applying of the plurality of separation voltages to the introduced sample a plurality of times; and
determining a collision cross-section (CCS) value for the sample based on the applied separation voltages and their corresponding determined optimum compensation voltages variation as a function of the applied separation voltages.

2. The method of claim 1, wherein sequentially applying the plurality of separation voltages comprises sequentially applying a plurality of RF separation voltages.

3. The method of claim 1, wherein sequentially applying the plurality of separation voltages comprises sequentially applying the plurality of separation voltages over a maximum range of voltages allowable in the DMS device.

4. The method of claim 1, wherein sequentially applying the plurality of separation voltages comprises sequentially applying discrete incremental separation voltages.

5. The method of claim 1, wherein:
the opposing electrodes of the DMS device are opposing planar electrodes; and
sequentially applying the plurality of separation voltages comprises sequentially applying the plurality of separation voltages between the opposing planar electrodes.

6. The method of claim 1, wherein:
the opposing electrodes of the DMS device are opposing curved electrodes; and
sequentially applying the plurality of separation voltages comprises sequentially applying the plurality of separation voltages between the opposing curved electrodes.

7. The method of claim 1, wherein repeating the sequentially applying the plurality of separation voltages is performed over a predetermined period of time.

8. The method of claim 7, wherein the predetermined period of time corresponds to an elution time associated with a chromatography peak.

9. The method of claim 1, further comprising identifying one or more compounds present in the sample based on the determined CCS value.

10. A system of differential mobility spectrometry (DMS), the system comprising:
a sample input device;
a DMS device fluidically coupled to the sample input device;
a DC voltage source;
an RF voltage source;
a mass analysis device;
a processor operatively coupled to the DMS device, the DC voltage source, the RF voltage source and the mass analysis device; and
a memory coupled to the processor, the memory storing instructions that, when executed by the processor, perform a set of operations comprising:
introducing, via the sample input device, a sample at an opening of the DMS device;
sequentially applying, via the RF voltage source, a plurality of separation voltages between opposing electrodes of the DMS device, wherein sequentially applying the plurality of separation voltages comprises, for each applied separation voltage:
applying, via the DC voltage source, a plurality of incrementally increasing compensation voltages between the opposing electrodes of the DMS device;
following each applied compensation voltage:
interrupting, via the processor, application of the separation voltage and of the compensation voltage; and
collecting, via the processor and the mass analysis device, mass spectrometry (MS) data for the sample exiting the DMS device while the separation voltage and the compensation voltage are interrupted; and
determining, via the processor, an optimum compensation voltage out of the plurality of compensation voltages based on the collected MS data;
repeating, via the processor, the sequentially applying the plurality of separation voltages to the introduced sample a plurality of times; and
determining, via the processor, a collision cross-section (CCS) value for the sample based on the applied separation voltages and their corresponding determined optimum compensation voltages variation as a function of the applied separation voltages.

11. The system of claim 10, wherein the set of instructions further comprises sequentially applying the plurality of separation voltages by sequentially applying a plurality of RF separation voltages.

12. The system of claim 11, wherein the RF separation voltages comprise voltages of different frequencies.

13. The system of claim 10, wherein the set of instructions further comprises sequentially applying the plurality of separation voltages by sequentially applying the plurality of separation voltages over a maximum range of voltages allowable in the DMS device.

14. The system of claim 10, wherein the set of instructions further comprises sequentially applying the plurality of separation voltages by sequentially applying discrete incremental separation voltages.

15. The system of claim 10, wherein:
the opposing electrodes of the DMS device are opposing planar electrodes; and
the set of instructions further comprises sequentially applying the plurality of separation voltages by sequentially applying the plurality of separation voltages between the opposing planar electrodes.

16. The system of claim 10, wherein:
the opposing electrodes of the DMS device are opposing curved electrodes; and
the set of instructions further comprises sequentially applying the plurality of separation voltages by sequentially applying the plurality of separation voltages between the opposing curved electrodes.

17. The system of claim 10, wherein the set of instructions further comprises repeating the sequentially applying the plurality of separation voltages over a predetermined period of time.

18. The system of claim 10, wherein the set of instructions further comprises identifying one or more compounds present in the sample based on the determined CCS value.

19. The system of claim 18, wherein the set of instructions comprises identifying the one or more compounds based on a comparison of the determined CCS value with contents of a library of SV-CV curves.

20. The system of claim 17, wherein the set of instructions comprises identifying the one or more compounds based on a partial alpha-curve function derived from an SV-CV curve and compared to a library of alpha-curve function.
